(19) United States
(12) Patent Application Publication
(10) Pub. No.: US 2026/0292793 A1
(43) Pub. Date: Sep. 24, 2026

(54) DEVICES AND METHODS FOR USAGE STATUS INDICATION OF TRANSMISSION OCCASIONS FOR CONFIGURED GRANT

(71) Applicant: LENOVO (BEIJING) LIMITED, Beijing (CN)

(72) Inventors: Ruixiang Ma, Beijing (CN); Haipeng Lei, Beijing (CN)

(73) Assignee: Lenovo (Beijing) Limited, Beijing (CN)

(21) Appl. No.: 19/168,062

(22) PCT Filed: Apr. 7, 2023
(86) PCT No.: PCT/CN2023/086911

§ 371 Date: Sep. 23, 2025

(51) Int. Cl. H04W 72/0446; H04W 72/231

(52) U.S. Cl. CPC H04W 72/0446; H04W 72/231

(57) ABSTRACT

Embodiments of the present disclosure relate to devices and methods for usage status of transmission occasions for CG. A terminal device determines, from a plurality of TOs in a time duration for a CG configuration, a set of TOs for transmitting indication information. The indication information indicates usage status of at least one TO among the plurality of TOs. The terminal device transmits the indication information to a network device based on the determined sets of TOs. In this way, the indication information can be transmitted in part of a plurality of TOs in a time duration for a CG configuration, and thus the signalling overhead can be reduced.

### FIELD

Embodiments of the present disclosure generally relate to the field of communication, and in particular to devices, methods, apparatus, a non-transitory computer readable medium and computer program product for usage status of transmission occasions for a configured grant (CG).

### BACKGROUND

New Radio (NR), which is also called as the 5th generation (5G) mobile network, is a new global wireless standard after 1G, 2G, 3G, and 4G networks. The NR enables a new kind of network that is designed to connect virtually everyone and everything together including machines, objects, and devices. NR wireless technology is meant to deliver higher multi-Gbps peak data speeds, ultra-low latency, more reliability, massive network capacity, increased availability, and a more uniform user experience to more users. Higher performance and improved efficiency empower new user experiences and connects new industries.

Xtended Reality (XR) is a broad term covering Augmented Reality (AR), Mixed Reality (MR) and Virtual Reality (VR). Along with Cloud Computing, XR applications typically require high throughput and low latency, and have a big packet size and variable data packet size. To realize the low latency requirement and the big packet size, it has been decided to support multiple configure grant (CG) physical uplink shared channel (PUSCH) transmission occasions (TOs) in a period of a single CG PUSCH configuration. Then the packet could be transmitted in the all or parts of configured TOs immediately if it arrives. However, configured TO may not be utilized efficiently and further enhancements on TO indications for CG configuration are still needed.

### SUMMARY

In general, example embodiments of the present disclosure provide devices, methods, apparatus, a non-transitory computer readable medium and computer program product for transmission occasion indications for a CG.

In a first aspect, there is provided a terminal device. The terminal device comprises a processor and a transceiver coupled to the processor. The processor is configured to: determine, from a plurality of TOs in a time duration for a CG configuration, a set of TOs for transmitting indication information, wherein the indication information indicates usage status of at least one TO among the plurality of TOs; and transmit, via the transceiver, the indication information to a network device based on the determined sets of TOs.

In a second aspect, there is provided a network device. The network device comprises a processor and a transceiver coupled to the processor. The processor is configured to: determine, from a plurality of TOs in a time duration for a CG configuration for a terminal device, a set of TOs for receiving indication information, wherein the indication information indicates usage status of at least one TO among the plurality of TOs; and receive, via the transceiver, the indication information from the terminal device based on the determined sets of TOs.

In a third aspect, there is provided a method performed by a terminal device. The method comprises: determining, from a plurality of TOs in a time duration for a CG configuration, a set of TOs for transmitting indication information, wherein the indication information indicates usage status of at least one TO among the plurality of TOs; and transmitting, via a transceiver of the terminal device, the indication information to a network device based on the determined sets of TOs.

In a fourth aspect, there is provided a method performed by a network device. The method comprises: determining, from a plurality of TOs in a time duration for a CG configuration for a terminal device, a set of TOs for receiving indication information, wherein the indication information indicates usage status of at least one TO among the plurality of TOs; and receiving, via a transceiver of the network device, the indication information from the terminal device based on the determined sets of TOs.

In a fifth aspect, there is provided an apparatus for communication. The apparatus comprising means for performing the method according to the third aspect above.

In a sixth aspect, there is provided an apparatus for communication. The apparatus comprising means for performing the method according to the fourth aspect above.

In a seventh aspect, there is provided a terminal device. The terminal device comprises a processor and a memory coupled to the processor. The processor is configured to cause the terminal device to: determine, from a plurality of TOs in a time duration for a CG configuration, a set of TOs for transmitting indication information, wherein the indication information indicates usage status of at least one TO among the plurality of TOs; and transmit the indication information to a network device based on the determined sets of TOs.

In an eighth aspect, there is provided a network device. The network device comprises a processor and a transceiver coupled to the memory. The processor is configured to cause the terminal device to: determine, from a plurality of TOs in a time duration for a CG configuration for a terminal device, a set of TOs for receiving indication information, wherein the indication information indicates usage status of at least one TO among the plurality of TOs; and receive the indication information from the terminal device based on the determined sets of TOs.

In a ninth aspect, there is provided a non-transitory computer readable medium. The non-transitory computer readable medium having program instructions stored thereon. The program instructions, when executed by an apparatus, causing the apparatus at least to perform the method according to the third aspect or the fourth aspect above.

In a tenth aspect, there is provided a computer program product. The computer program product comprises instructions. The instructions, when executed by a processor of an apparatus, causing the apparatus at least to perform the method according to the third aspect or the fourth aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates an example network environment in which some embodiments of the present disclosure can be implemented;

FIG. 2 illustrates an example signaling chart of an example process according to some embodiments of the present disclosure;

FIG. 3 illustrates an example diagram of TOs, in which the TOs for transmitting indication information have a fixed interval, according to some embodiments of the present disclosure;

FIGS. 4A and 4B illustrate example diagrams of TOs, in which a bitmap indicates TOs used for transmitting indication information, according to some embodiments of the present disclosure;

FIGS. 5A and 5B illustrate example diagrams of TOs, in which the TOs for transmitting indication information are determined based on a number of the TOs in a time duration, according to some embodiments of the present disclosure;

FIGS. 6A to 6E illustrate example diagrams of TOs, in which hybrid automatic repeat request (HARQ) process numbers (HPNs) for the TOs are indicated, according to some embodiments of the present disclosure;

FIG. 7 illustrates a flowchart of a method implemented at a terminal device according to some embodiments of the present disclosure;

FIG. 8 illustrates a flowchart of a method implemented at a network device according to some embodiments of the present disclosure; and

FIG. 9 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (loT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term “resource,” “transmission resource,” “resource block,” “physical resource block,” “uplink resource,” or “downlink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

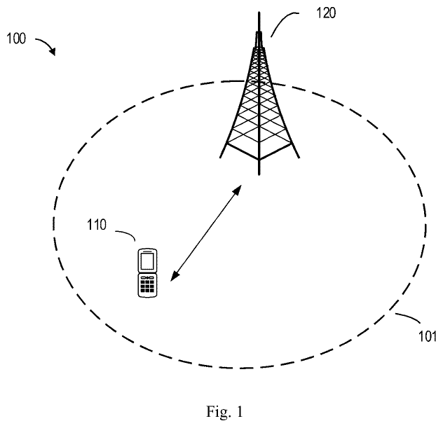

FIG. 1 illustrates an example network environment 100 in which example embodiments of the present disclosure may be implemented. The environment 100, which may be a part of a communication network, comprises terminal devices and network devices.

As illustrated in FIG. 1, the communication network 100 may comprise a terminal device 110 (hereinafter may also be referred to as user equipment 110 or a UE 110). The communication network 100 may further comprise a network device 120. The network device 120 may manage a cell 101. The terminal device 110 and the network device 120 may communicate data and control information to each other in the coverage of the cell. A link from the network device 120 to the terminal device 110 is referred to as a downlink (DL), while a link from the terminal device 110 to the network device 120 is referred to as an uplink (UL).

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

Currently, in wireless communications, physical uplink shared channel (PUSCH) transmission(s) can be dynamically scheduled by an uplink (UL) grant in downlink control information (DCI), or the transmission can use CG resources configured by a CG Type 1 or Type 2. The configured grant Type 1 PUSCH transmission is semi-statically configured to operate upon reception of a higher layer parameter of configuredGrantConfig including rrc-ConfiguredUplinkGrant without detection of an UL grant in a DCI. The configured grant Type 2 PUSCH transmission is semi-persistently scheduled by an UL grant in a valid activation DCI after reception of a higher layer parameter configuredGrantConfig not including rrc-ConfiguredUplinkGrant.

As indicated above, to realize the low latency requirement and the big packet size, it has been decided to support multiple CG PUSCH TOs in a period of a single CG PUSCH configuration. Then the packet could be transmitted in the all or parts of configured TOs immediately if it arrives. Considering gNB does not know the real size of a packet and how much TO would be used by the UE, the occupied number of TOs might be smaller than the configured number of TOs, which means there would be some TOs wasted, Therefore, Further enhancement on transmission for CG is required to improve the resource usage for CG.

To address this issue, the present disclosure proposes that the UE indicates unused TOs to the gNB, which would be useful to increase resource utilization, because gNB could re-use this resource to transmit other data. And the indication could be transmitted in uplink control information (UCI).

On the other hand, the inventors further notice that if the UCI is transmitted in every TO, the signaling overhead would be very large, which would decrease the capacity of the system and also would waste the UE battery. Therefore, it needs a solution to determine the TO used to transmit the UCI.

Given the above, embodiments of the present disclosure provide a solution for usage status indication of TOs for a CG. In one aspect of the solution of the present disclosure, a terminal device determines, from a plurality of TOs in a time duration for a CG configuration, a set of TOs for transmitting indication information. The indication information indicates usage status of at least one TO among the plurality of TOs. The terminal device transmits the indication information to a network device based on the determined sets of TOs.

In this way, the indication information can be transmitted in part of a plurality of TOs in a time duration for a CG configuration, and thus the signalling overhead can be reduced. Moreover, the unused TOs indicated by the indication information may be used for other transmissions, and the resource utilization rate and the capacity of the system can be increased.

Further, for each TO, UE could determine the HARQ process number by himself and then indicate the determined HPN to the gNB. Then there would be problem that if the UCI is not transmitted in every TO, then for the TO without UCI transmission, how does the gNB know the HPN for the PUSCH in the TO. Considering this, in some embodiments or another aspect of the present disclosure, the indication information can additionally or alternatively indicate HPNs for the plurality of TOs.

It is to be appreciated that the solutions as proposed in the present disclosure are described with reference to XR applications, only for illustrative purposes; however, the embodiments of the present disclosure are not limited thereto and they may be applied to other applications or scenarios with similar issues to XR applications.

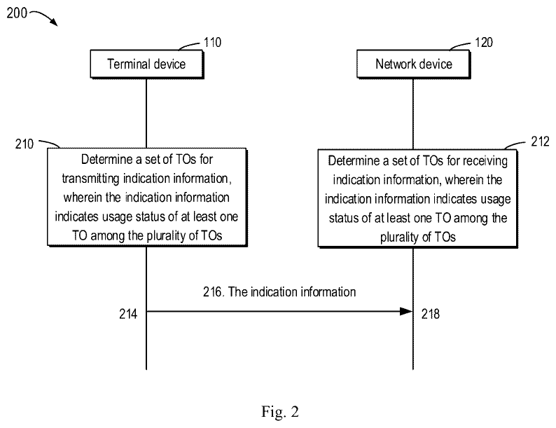

Principles and implementations of embodiments of the present disclosure will be described in detail below with reference to FIGS. 2-9.

### Example Method

FIG. 2 illustrates an example signaling chart illustrating an example process 200 according to some embodiments of the present disclosure. For the purpose of discussion, the example 200 will be described with reference to FIG. 1, and the process 200 may involve the terminal device 110 and the network device 120 as shown in FIG. 1.

As shown in FIG. 2, the terminal device 110 determines 210, from a plurality of TOs in a time duration for a CG configuration, a set of TOs for transmitting indication information. The indication information indicates usage status of at least one TO among the plurality of TOs.

In some embodiments, the usage status may indicate or comprise a used status representing that the at least one TO is used for transmitting an uplink data. Alternatively, the usage status may indicate or comprise an unused status representing the at least one TO is unused for transmitting the uplink data.

Then, the terminal device 110 transmits 214 the indication information 216 to the network device 120 based on the determined sets of TOs.

In some embodiments, the sets of TOs may have a fixed interval. For example, any two TOs used to transmit the indication information may have a fixed interval. The fixed interval may be predefined by a specification, a standard, protocol, etc., configured or pre-configured by the network device 120, or predetermined in any way.

For illustrative purpose, reference will made to FIG. 3, which illustrates an example diagram 300 of TOs, in which the TOs for transmitting indication information have a fixed interval. In FIG. 3, blocks 301-308 and 311-318 represents a TO in a time duration and the dark blocks (e.g., 301, 304, 307, 311, 314 and 317) represent TOs for transmitting indication information.

Wherein the fixed interval presents the TO number between the any two TO used to transmit the indication information or the TO number between the any two TO used to transmit the indication information plus 1 TO.

As shown in FIG. 3, in time duration 1 for example configured by CG 1, the TOs for transmitting indication information (i.e., TOs 301, 304, 307) have a fixed interval, i.e., 2 TOs. Alternatively, the fixed interval could be 3 TOs. In time duration 2 for example configured by CG 1, the TOs for transmitting indication information have the same fixed interval. Alternatively, the two fixed internal may also be different.

In some embodiments, the fixed interval can be configured by the network device 120. Alternatively, or additionally, the fixed interval can be predetermined. In this situation, the terminal device 110 may determine the number of bits of the indication information based on the fixed interval. For example, assuming TO number of the fixed interval is M, then the number of bits N of the indication information could be: N=M or N=┌log 2(M)┐, wherein ┌•┐ represents rounding up.

In some embodiments, the terminal device 110 may determine the fixed interval based on the number of bits of the indication information. For example, if there are 2 bits for the indication information, then the interval could be 4 TOs (i.e., for number of TO indication) or could be 2 TOs for bitmap indication.

In some embodiments, the terminal device 110 may determine the first TO (e.g., TO 301) of the plurality of TOs in a time duration as a start TO of the set of TOs for transmitting indication information. Alternatively, the terminal device 110 may determine the first used TO (e.g., the first TO that is used for transmitting an unlink data) of the plurality of TOs as the start TO of the set of TOs. Alternatively, the start TO can be indicated by the network device 120.

Since the start TO and fixed interval are determined, the whole set of TOs for transmitting indication information are known for the terminal device 110.

In some embodiments, the terminal device 110 may receive a bitmap from the network device 120, and the bitmap indicates the set of TOs for transmitting the indication information.

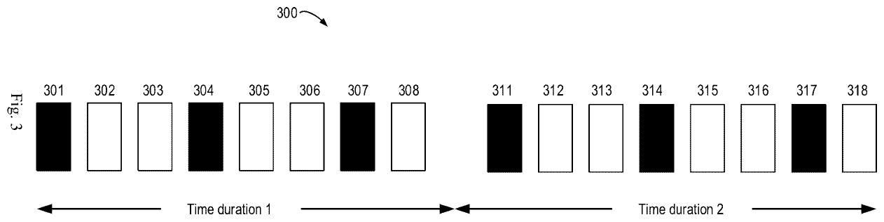

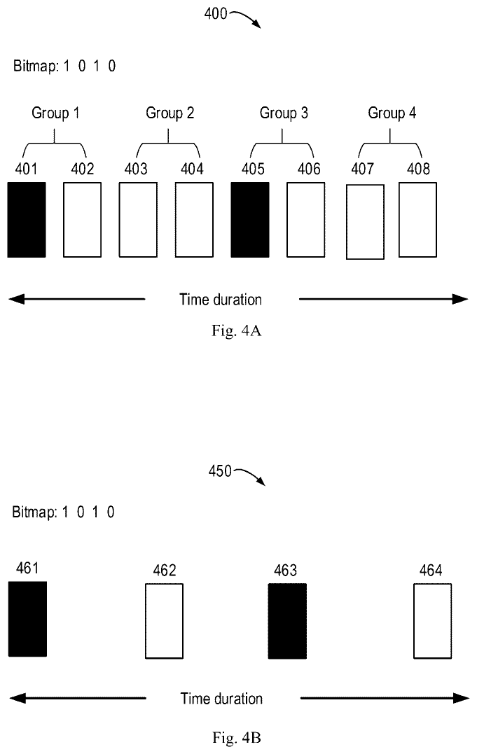

For illustrative purpose, reference will made to FIGS. 4A and 4B, which illustrate example diagrams 400 and 450 of TOs respectively, in which a bitmap indicates TOs used for transmitting indication information. The number of bits of the bitmap may be predetermined. For example, if the number of TOs in a time duration(s) is larger than the number of bits in the bitmap, a bit of the bitmap may indicate whether a TO group, in the plurality of TOs, is used for transmitting the indication information, as shown in FIG. 4A. In this case, as an example, a first TO or a last TO or any other predefined TO in the TO group (when the TO group include more than two TOs) may be determined as one of the sets of TOs for transmitting indication information.

In FIG. 4A, the bitmap has 4 bits for a time duration and there are 8 TOs in a time duration. In this case, TOs in a time duration could be grouped into 4 TO groups and each TO group includes 2 adjacent TOs. For example, in the time duration, TOs 401-402 are grouped into group 1, TOs 403-404 are grouped into group 2, TOs 405-406 are grouped into group 3, and TOs 407-408 are grouped into group 4. A bit of the bitmap can correspond to a TO group. Since TO 401 in group 1 and TO 405 in group 3 are used for transmitting indication information, the bits corresponding to group 1 and group 3 may be 1 and the bits corresponding to group 2 and group 4 may be 0 since they are not used for transmitting the indication information, and thus the bitmap may be “1010”.

It should be understood that the grouping manner above is provided as an example, and other grouping manners are possible and also within the scope of the present disclosure. It should also be understand that a bit value 0 may indicates a group having an indication information transmission and a bit value 1 may indicates a group having no indication information transmission, which is also within the scope of the present disclosure.

In some embodiments, at least some bits of the bitmap respectively indicate whether a TO, in the plurality of TOs, is used for transmitting transmit the indication information. For example, if the number of TOs in the time duration is smaller than the number of bits in the bitmap, then Least Significant Bit (LSB) could indicate whether a TO has an indication information transmission at the or not. If the number of TOs in the time duration is equal to the number of bits in the bitmap, then each bit in the bitmap could indicate whether a TO has an indication information transmission or not.

FIG. 4B shows a situation that each bit in the bitmap indicates one TO. In FIG. 4B, there are 4 TOs 461-464 in the time duration and the bitmap has 4 bits. Thus, each bit in the bitmap could indicate one TO. As shown in FIG. 4B, on TOs 461 and 463 there are indication information transmissions while on TOs 462 and 464 there are no indication information transmission. Therefore, the bitmap could be “1010”.

In some embodiments, the terminal device 110 may determine a number of bits of the indication information based on a largest TO number between two adjacent TOs in the set of TOs.

In some embodiments, the terminal device 110 may determine the set of TOs for transmitting the indication information based on a number of the plurality of TOs. For example, a threshold may be predefined, if the number of the plurality of TOs in the time duration is larger than the threshold, then an additional TO besides a start TO is needed for transmitting the indication information.

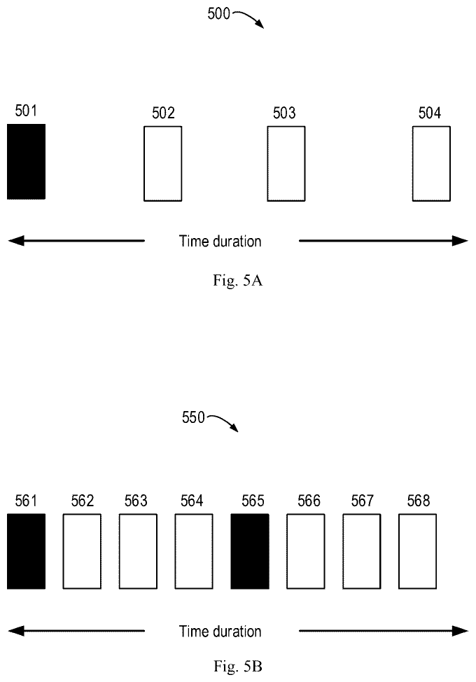

For illustrative purpose, reference will made to FIGS. 5A and 5B, which illustrate example diagrams 500 and 550 of TOs respectively, in which the TOs for transmitting indication information are determined based on a number of the TOs in a time duration.

As an example, the threshold may be 4. In FIG. 5A, there are only 4 TOs 501-504 in the time duration, and thus one TO (e.g., the start TO) is enough for the transmitting indication information.

In some embodiments, the terminal device 110 may determine a first TO (e.g., TO 501 in FIG. 5A) of the plurality of TOs in the time duration as the start TO of the set of TOs for transmitting the indication information. Alternatively, the terminal device 110 may determine the first used TO (e.g., the first TO that is used for transmitting an unlink data) of the plurality of TOs as the start TO of the set of TOs. Alternatively, the start TO can be indicated by the network device 120.

On the other hand, when the number of the plurality of TOs is larger than a predefined threshold, the terminal device 110 may determine an additional TO besides a start TO as one of the set of TOs. For example, in FIG. 5B, there are 8 TOs 561-568 in the time duration, which is larger than the predefined threshold 4. Therefore, in addition to the first TO, an additional TO is needed for transmitting the indication information. The terminal device 110 may determine a TO immediately after the predetermined threshold of the plurality of TOs as the additional TO. For example, in FIG. 5B, the additional TO may be TO 565.

Alternatively, the terminal device 110 may determine a TO with an index equal to or a minimum index larger than a half of the number of the plurality of TOs as the additional TO. For example, if there are 12 TOs in the time duration, the additional TO could be the sixth TO, if there are 13 TOs in the time duration, the additional TO could be the seventh TO, and so on.

In some embodiments, the terminal device 110 may determine the set of TOs based on the number of the plurality of TOs in the time duration according to a corresponding relationship between the set of TOs and the number of the plurality of TOs. The corresponding relationship may be indicated by the network device 120, predefined by a specification, a standard, a protocol, etc., or predetermined in any way. For example, for each candidate number of the plurality of TOs, the corresponding set of TOs for transmitting the indication information may be indicated by network device 120 or predefined, and then the terminal device 110 can determine the set of TOs according to the number of plurality of TOs.

Similarly, the terminal device 110 may determine a number of bits of the indication information based on a largest TO number between two adjacent TOs in the set of TOs. For example, assuming T largest TO number between two adjacent TOs in the set of TOs is M, then the number of bits N of the indication information could be: N=M or N=┌log 2(M)┐, wherein ┌•┐ represents rounding up.

Reference is made back to FIG. 2, in a similar way to those, the network device 120 determines 212, from a plurality of TOs in a time duration for a CG configuration for a terminal device, a set of TOs for receiving indication information. The indication information indicates usage status of at least one TO among the plurality of TOs.

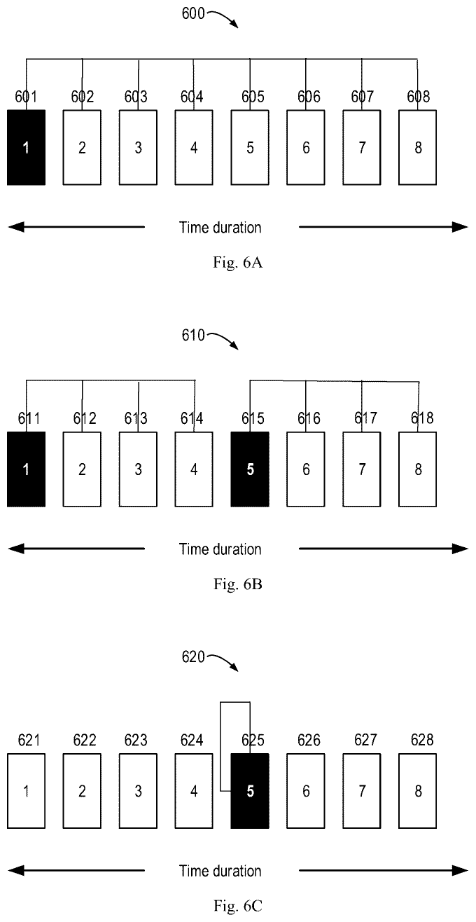

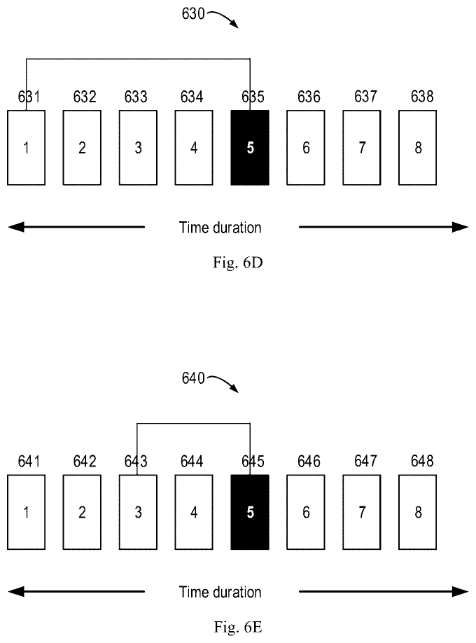

In some embodiments or another aspect of the present disclosure, the indication information may additionally or alternatively indicate HPNs for the transmitted uplink data (e.g., PUSCH) on the used TOs. Only for illustrative purposes, details will be described in below with reference to FIGS. 6A to 6E, which illustrate example diagrams 600-640 of TOs respectively, in which HPNs for the TOs are indicated.

Referring to FIG. 6A. In some embodiments, the indication information may indicate HPNs for all of the plurality of TOs in the time duration. For example, the indication information transmitted in TO 601 indicates the HPNs for uplink data (e.g., PUSCH) on all TOs 601-608 to be 1-8 respectively.

In some embodiments, the number of bits of the indication information may be determined by the plurality of TOs in the time duration. Alternatively, the number of bits of the indication information may be determined by the number of available TOs in the time duration. The number of bits to indicate the HPN for each TO may be determined by the configured total number of HPN, or predefined.

Reference is made to FIG. 6B. In some embodiments, the indication information may indicate HPNs for current TO used for transmitting the indication information and multiple TOs between the current TO that is used for transmitting the indication information and the following TO in the at least two of the set of TOs. For example, on TO 611 and TO 615, there are indication information transmissions, and there are TOs 612-614 between TO 611 and TO 615. The indication information transmitted in TO 611 could indicate the HPNs for uplink data (e.g., PUSCH) on TOs 612-614 to be 2-4, wherein the HPN for uplink data on TO 611 could also be indicated to be 1. The indication information transmitted on TO 615 could indicate the HPNs for uplink data on TOs 616-618 (which are between the TO 615 and next TO for transmitting the indication information) to be 6-8, wherein the HPN for uplink data on TO 615 could be indicated to be 5.

In some embodiments, the number of bits of the indication information may be determined based on the interval of current indication information and next indication information, e.g., between TO 611 and TO 615. Alternatively, the number of bits of the indication information may be determined based on the interval of current indication information and next indication information plus 1. For example, assuming interval is M, then the indication information could indicate M+1 HPN for M+1 TOs including current TO used for transmitting the indication information and multiple TOs between the current TO that is used for transmitting the indication information and the following TO in the at least two of the set of TOs. The number of bits to indicate the HPN for each TO may be determined by the configured total number of HPN, or predefined.

Reference is further made FIG. 6C. In some embodiments, the indication information may indicate an HPN of one of the set of TOs, on which the indication information is transmitted. That is, the indication information may indicate an HPN for uplink data on the current TO. For example, the indication information transmitted in TO 625 could indicate the HPN for uplink data on TO 625 to be 5, the HPNs for uplink data on TOs 624, 623, 622, 621 may be determined at the network side by decreasing 1, one by one, and the HPNs for uplink data on TOs 626-628 may be determined by increasing 1, one by one.

Reference is made FIG. 6D. In some embodiments, the indication information may indicate an HPN for the first or last TO of the plurality of TOs. Alternatively, or additionally, the indication information may indicate an HPN for the first or last used TO of the plurality of TOs for transmitting an uplink data. For example, as shown in FIG. 6D, the indication information transmitted in current TO 635 could indicate the HPN for uplink data (e.g., PUCSH) on TO 631 to be 1, and the HPNs for later configured/available PUSCHs on later TOs may be determined at the network side by increasing 1, one by one.

Referring to FIG. 6E. In some embodiments, the indication information may indicate an HPN for a TO having a predetermined offset relative to the first TO of the plurality of TOs or a TO that is used to transmit the indication information. For example, as shown in FIG. 6E, the indication information transmitted in current TO 645 could indicate the HPN for uplink data (e.g., PUCSH) on a TO with an offset value of −2 (i.e., TO 643) to be 3, the HPNs for uplink data on TOs before TO 643 could be determined at the network side by decreasing 1 one by one, and the HPNs for uplink data on later TOs could be determined at the network side by increasing 1 one by one.

Reference is made back to FIG. 2, the terminal device 110 transmit the indication information 216 to the network device 120. At the network side, the network device 120 receives 218 the indication information 216 from the terminal device 110 based on the determined sets of TOs. The network device 120 may determine usage status of TOs based on the indication. In some embodiments, the indication information may additionally or alternatively include information on the HPNS for TOs, and thus the network device 120 may determine the HPNs for TOs based on the indication information.

It should be understood that, the above methods described by referring FIGS. 3 to 6E can be also performed by the network device 120 unless there is a logical conflict. Details will not be described again.

In some embodiments, the terminal device 110 may transmit the indication information to the network device 120 in UCI. In some embodiments, the terminal device 110 may transmit the indication information to the network device 120 on a TO in the set of TOs, on which the uplink data is transmitted. For example, if there is PUSCH transition in the a TO of the set of TOs in the time duration, the terminal device 110 may transmit the indication information in the TO, otherwise, it would not transmit the indication the information.

In some embodiments, the terminal device 110 may transmit the indication information to the network device 120 on an uplink control resource, when a TO in the set of TOs is unused for transmitting the uplink data. For example, if there is no PUSCH transmission in the determined set of TOs for transmitting the indication information, then the indication information may be transmitted in an uplink control resource, such as a physical uplink control channel (PUCCH) resource.

In some embodiments, the terminal device 110 may receive a configuration of a set of uplink control resources for transmitting the indication information from the network device 120. Then, the terminal device 110 may determine, from the set of uplink control resources, the uplink control resource for transmitting the indication information based on the number of bits of the indication information.

For example, the terminal device 110 may receive a configuration to configure a PUCCH resource, and the PUCCH resource is used for the indication information transmission, the indication information is used to indicate the unused TO. In this case, a PUCCH resource set could be configured by the network device 120, and the terminal device 110 according to the bits of indication information to choose one PUCCH resource from the set.

In some embodiments, the terminal device 110 may determine one of a set of uplink control resources for HARQ feedback as the uplink control resource for the indication information transmission based on the number of bits of the indication information. The uplink control resource may be an uplink control resource with smallest index in the set of uplink control resources.

For example, the PUCCH resource set for HARQ-ACK of dynamic scheduling or semi-persistent scheduling (SPS) PDSCH. The first PUCCH resource in the determined PUCCH resource set is used as the uplink control resource for the indication information transmission.

In some embodiments, the terminal device 110 may determine a time unit for the uplink control resource based on an ending position (e.g., ending symbol) of the TO which is unused for transmitting the uplink data. The network device 120 may also determine the time unit for the uplink control resource.

For example, the time unit to transmit the PUCCH is determined based on the TO that is used to transmit the indication information. The time unit (e.g., slot or sub-slot) to transmit the PUCCH may be determined based on the ending symbol of the determined TO which is unused for transmitting the uplink data. For example, assuming the determined TO is in symbol #8 in a slot, and assuming the sub-slot length is 2, then the time unit to transmit the PUCCH may be in fifth sub-slot in that slot.

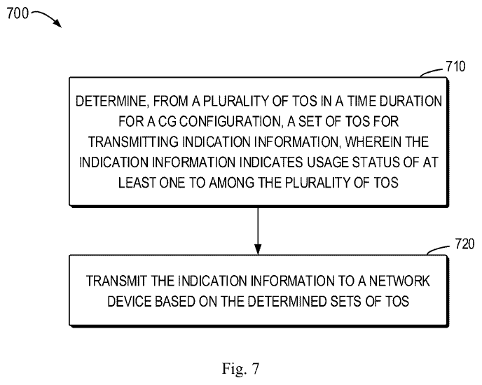

FIG. 7 illustrates a flowchart of a method 700 implemented at a terminal device according to some embodiments of the present disclosure. In some embodiments, the method 700 can be implemented at a communication device, such as the terminal device 110 as shown in FIG. 1. In some other embodiments, the method 700 may be implemented at devices not shown in FIG. 1. Further, it is to be understood that the method 700 may include additional blocks not shown and/or may omit some blocks as shown, and the scope of the present disclosure is not limited in this regard. For the purpose of discussion, the method 700 will be described from the perspective of the terminal device 110 with reference to FIG. 1 and FIG. 2.

At block 710, the terminal device 110 determines, from a plurality of TOs in a time duration for a CG configuration, a set of TOs for transmitting indication information. The indication information indicates usage status of at least one TO among the plurality of TOs.

At block 720, the terminal device 110 transmits the indication information to the network device 120 based on the determined sets of TOs.

In some embodiments, the usage status may comprise that the at least one TO is used for transmitting an uplink data. Alternatively, the usage status may comprise that the at least one TO is unused for transmitting the uplink data.

In some embodiments, the sets of TOs may have a fixed interval. In some embodiments, the fixed interval may be configured by the network device or predetermined. In some embodiments, the terminal device 110 may determine a number of bits of the indication information based on the fixed interval. Alternatively, or additionally, the terminal device 110 may determine the fixed interval based on the number of bits of the indication information.

In some embodiments, the terminal device 110 may receive a bitmap from the network device. The bitmap may indicate the set of TOs for transmitting the indication information. In some embodiments, the number of bits of the bitmap may be predetermined.

In some embodiments, a bit of the bitmap may indicate whether a TO group, in the plurality of TOs, is used for transmitting the indication information. A first TO or a last TO or a predefined TO in the TO group may be determined as one of the sets of TOs. Alternatively, or additionally, at least some bits of the bitmap may respectively indicate whether a TO, in the plurality of TOs, is used for transmitting transmit the indication information.

In some embodiments, the terminal device 110 may determine the set of TOs based on a number of the plurality of TOs. In some embodiments, the terminal device 110 may determine an additional TO besides a start TO as one of the set of TOs, when the number of the plurality of TOs is larger than a predefined threshold. In some embodiments, the terminal device 110 may determine a start TO of the set of TOs as a first TO of the plurality of TOs. Alternatively, the terminal device 110 may determine a start TO of the set of TOs as a first used TO of the plurality of TOs. Alternatively, the terminal device 110 may determine a start TO of the set of TOs as a TO indicated by the network device 120.

In some embodiments, the terminal device 110 may determine the additional TO as a TO immediately after the predetermined threshold of the plurality of TOs. Alternatively, the terminal device 110 may determine the additional TO as a TO with an index equal to or a minimum index larger than a half of the number of the plurality of TOs.

In some embodiments, the terminal device 110 may determine the set of TOs based on the number of the plurality of TOs according to a corresponding relationship between the set of TOs and the number of the plurality of TOs. The corresponding relationship may be indicated by the network device or predetermined.

In some embodiments, the terminal device 110 may determine a number of bits of the indication information based on a largest TO number between two adjacent TOs in the set of TOs.

In some embodiments, the indication information may further indicate HPNs for all of the plurality of TOs. Alternatively, or additionally, the indication information may further indicate HPNs for multiple TOs between a TO used for transmitting the indication information and the following TO in the at least two of the set of TOs. Alternatively, or additionally, the indication information may further indicate an HPN of the one of the set of TOs, on which the indication information is transmitted. Alternatively, or additionally, the indication information may further indicate an HPN for the first or last TO of the plurality of TOs. Alternatively, or additionally, the indication information may further indicate an HPN for the first or last used TO of the plurality of TOs for transmitting an uplink data. Alternatively, or additionally, the indication information may further indicate an HPN for a TO having a predetermined offset relative to the first TO or a TO used to transmit the indication information.

In some embodiments, the terminal device 110 may transmit the indication information in UCI. In some embodiments, the terminal device 110 may transmit the indication information on a TO in the set of TOs, on which the uplink data is transmitted. In some embodiments, the terminal device 110 may transmit the indication information on an uplink control resource when a TO in the set of TOs is unused for transmitting the uplink data.

In some embodiments, the terminal device 110 may receive, from the network device, a configuration of a set of uplink control resources for transmitting the indication information. The terminal device 110 may determine, from the set of uplink control resources, the uplink control resource based on the number of bits of the indication information. Alternatively, or additionally, the terminal device 110 may determine one of a set of uplink control resources for HARQ feedback as the uplink control resource based on the number of bits of the indication information. The uplink control resource may be an uplink control resource with smallest index in the set of uplink control resources.

In some embodiments, the set of uplink control resources may have priorities associated with a priority of the CG configuration. In some embodiments, the terminal device 110 may determine a time unit for the uplink control resource based on an ending position of the TO which is unused for transmitting the uplink data.

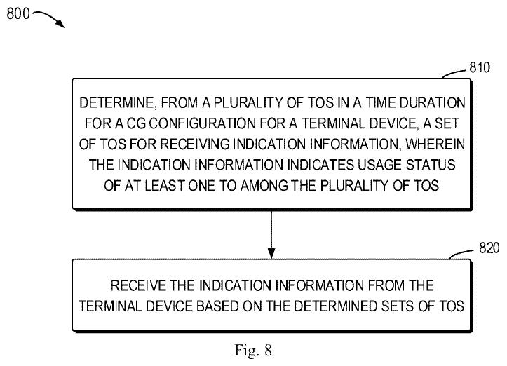

FIG. 8 illustrates a flowchart of a method 800 implemented at a network device according to some embodiments of the present disclosure. In some embodiments, the method 800 can be implemented at a communication device, such as the network device 120 as shown in FIG. 1. In some other embodiments, the method 800 may be implemented at devices not shown in FIG. 1. Further, it is to be understood that the method 800 may include additional blocks not shown and/or may omit some blocks as shown, and the scope of the present disclosure is not limited in this regard. For the purpose of discussion, the method 800 will be described from the perspective of the network device 120 with reference to FIG. 1 and FIG. 2.

At block 810, the network device 120 determines, from a plurality of TOs in a time duration for a CG configuration for a terminal device, a set of TOs for receiving indication information. The indication information indicates usage status of at least one TO among the plurality of TOs.

At block 820, the network device 120 receives the indication information from the terminal device 110 based on the determined sets of TOs.

In some embodiments, the usage status may comprise that the at least one TO is used for transmitting an uplink data by the terminal device 110. Alternatively, the usage status may comprise that the at least one TO is unused for transmitting the uplink data by the terminal device 110. In some embodiments, the network device 120 may determine the usage status of the at least one TO among the plurality of TOs based on the indication information.

In some embodiments, the sets of TOs may have a fixed interval. In some embodiments, the fixed interval may be configured by the network device or predetermined. In some embodiments, the network device 120 may determine a number of bits of the indication information based on the fixed interval. Alternatively, or additionally, the network device 120 may determine the fixed interval based on the number of bits of the indication information.

In some embodiments, the network device 120 may determine a bitmap based on the determined set of TOs. The bitmap indicates the set of TOs for receiving the indication information. Moreover, the network device 120 may transmit the bitmap to the terminal device. In some embodiments, the number of bits of the bitmap may be predetermined.

In some embodiments, a bit of the bitmap may indicate whether a TO group, in the plurality of TOs, is used for receiving the indication information. A first TO or a last TO or a predefined TO in the TO group may be determined as one of the sets of TOs. Alternatively, or additionally, at least some bits of the bitmap may respectively indicate whether a TO, in the plurality of TOs, is used for receiving the indication information.

In some embodiments, the network device 120 may determine the set of TOs based on a number of the plurality of TOs. In some embodiments, the network device 120 may determine an additional TO besides a start TO as one of the set of TOs, when the number of the plurality of TOs is larger than a predefined threshold. In some embodiments, the network device 120 may determine a start TO of the set of TOs as a first TO of the plurality of TOs. Alternatively, the network device 120 may determine a start TO of the set of TOs as a first used TO of the plurality of TOs. Alternatively, the network device 120 may indicate a start TO of the set of TOs.

In some embodiments, the network device 120 may determine the additional TO as a TO immediately after the predetermined threshold of the plurality of TOs. Alternatively, the network device 120 may determine the additional TO as a TO with an index equal to or a minimum index larger than a half of the number of the plurality of TOs.

In some embodiments, the network device 120 may determine the set of TOs based on the number of the plurality of TOs according to a corresponding relationship between the set of TOs and the number of the plurality of TOs. The corresponding relationship may be indicated by the network device or predetermined.

In some embodiments, the network device 120 may determine a number of bits of the indication information based on a largest TO number between two adjacent TOs in the set of TOs.

In some embodiments, the indication information may further indicate HPNs for all of the plurality of TOs. Alternatively, or additionally, the indication information may further indicate HPNs for multiple TOs between a TO used for receiving the indication information and the following TO in the at least two of the set of TOs. Alternatively, or additionally, the indication information may further indicate an HPN of the one of the set of TOs, on which the indication information is received. Alternatively, or additionally, the indication information may further indicate an HPN for the first or last TO of the plurality of TOs. Alternatively, or additionally, the indication information may further indicate an HPN for the first or last used TO of the plurality of TOs for receiving an uplink data. Alternatively, or additionally, the indication information may further indicate an HPN for a TO having a predetermined offset relative to the first TO or a TO used to receive the indication information.

In some embodiments, the network device 120 may receive the indication information in UCI. In some embodiments, the network device 120 may receive the indication information on a TO in the set of TOs, on which the uplink data is received. In some embodiments, the network device 120 may receive the indication information on an uplink control resource, when a TO in the set of TOs is unused for transmitting an uplink data by the terminal device.

In some embodiments, the network device 120 may transmit, to the terminal device 110, a configuration of a set of uplink control resources for transmitting the indication information. The network device 120 may determine, from the set of uplink control resources, the uplink control resource based on the number of bits of the indication information. Alternatively, or additionally, the network device 120 may determine one of a set of uplink control resources for HARQ feedback as the uplink control resource based on the number of bits of the indication information. The uplink control resource may be an uplink control resource with smallest index in the set of uplink control resources.

In some embodiments, the set of uplink control resources may have priorities associated with a priority of the CG configuration. In some embodiments, the network device 120 may determine a time unit for the uplink control resource based on an ending position of the TO which is unused for transmitting the uplink data.

In this way, the indication information can be transmitted in part of a plurality of TOs in a time duration for a CG configuration, and thus the signalling overhead can be reduced. Moreover, the unused TOs indicated by the indication information may be used for other transmissions, and the resource utilization rate and the capacity of the system can be increased.

Further, for each TO, UE could determine the HARQ process number by himself and then indicate the determined HPN to the gNB in the indication information. Thus, the gNB may know the HPN for the PUSCH in the TO. Considering this, in some embodiments or another aspect of the present disclosure, the indication information can additionally or alternatively indicate HPNs for the plurality of TOs.

### Example Apparatus

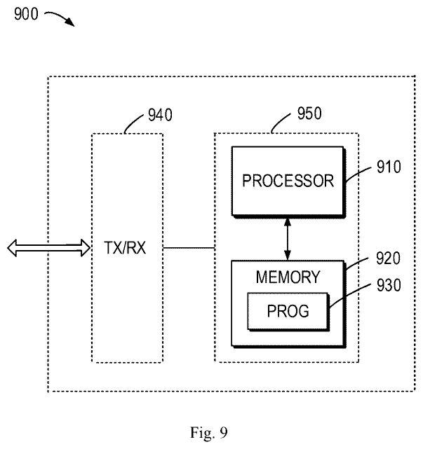

FIG. 9 illustrates a simplified block diagram of a device 900 that is suitable for implementing embodiments of the present disclosure. The device 900 can be considered as a further example implementation of the terminal device 110, and the network device 120 as shown in FIG. 1. Accordingly, the device 900 can be implemented at or as at least a part of the terminal device 110 or the network device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 930 is assumed to include program instructions that, when executed by the associated processor 910, enable the device 900 to operate in accordance with the embodiments of the present disclosure, as discussed herein with reference to FIGS. 1-8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, an apparatus capable of performing the method 700 (for example, the terminal device 110) may comprise means for performing the respective steps of the method 700. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 700.

In some embodiments, an apparatus capable of performing the method 800 (for example, the network device 120) may comprise means for performing the respective steps of the method 800. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 800.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device for wireless communication, comprising:
at least one memory; and
at least one processor coupled with the at least one memory and configured to cause the terminal device to:
determine, from a plurality of transmission occasions (TOs) in a time duration for a configured grant (CG) configuration, a set of TOs for transmitting indication information, wherein the indication information indicates usage status of at least one TO among the plurality of TOs; and
transmit the indication information to a network device based on the determined set of TOs.

2. The terminal device of claim 1, wherein the set of TOs have a fixed interval.

3. The terminal device of claim 2, wherein the fixed interval is configured by the network device or predetermined.

4. The terminal device of claim 1, wherein the at least one processor is further configured to cause the terminal device to receive a bitmap from the network device, wherein the bitmap indicates the set of TOs for transmitting the indication information.

5. The terminal device of claim 4, wherein a number of bits of the bitmap is predetermined.

6. The terminal device of claim 5, wherein:
a bit of the bitmap indicates whether a TO group, in the plurality of TOs, is used for transmitting the indication information, and wherein a first TO or a last TO or a predefined TO in the TO group is determined as one TO of the set of TOs; or
at least some bits of the bitmap respectively indicate whether a TO, in the plurality of TOs, is used for transmitting the indication information.

7. The terminal device of claim 1, wherein the at least one processor is configured to cause the terminal device to determine the set of TOs based on a number of the plurality of TOs.

8. The terminal device of claim 1, wherein the at least one processor is configured to cause the terminal device to determine a start TO of the set of TOs as one of:
a first TO of the plurality of TOs;
a first used TO of the plurality of TOs; or
a TO indicated by the network device.

9. The terminal device of claim 7, wherein the at least one processor is configured to cause the terminal device to determine the set of TOs based on the number of the plurality of TOs according to a corresponding relationship between the set of TOs and the number of the plurality of TOs, and the corresponding relationship is indicated by the network device or predetermined.

10. The terminal device of claim 1, wherein the indication information further indicates one of:
hybrid automatic repeat request (HARQ) process numbers (HPNs) for all of the plurality of TOs;
HPNs for multiple TOs between a TO used for transmitting the indication information and a following TO in at least two of the set of TOs;
an HPN of the one of the set of TOs, on which the indication information is transmitted;
an HPN for a first TO or a last TO of the plurality of TOs;
an HPN for the first TO or a last used TO of the plurality of TOs for transmitting an uplink data; or
an HPN for a TO having a predetermined offset relative to the first TO or a TO used to transmit the indication information.

11. The terminal device of claim 1, wherein the at least one processor is configured to cause the terminal device to transmit the indication information on a TO in the set of TOs, on which uplink data is transmitted.

12. The terminal device of claim 11, wherein the at least one processor is configured to cause the terminal device to transmit the indication information on an uplink control resource when the TO in the set of TOs is unused for transmitting the uplink data.

13. The terminal device of claim 12, wherein the at least one processor is configured to cause the terminal device to determine the uplink control resource by one of:
receiving, from the network device, a configuration of a set of uplink control resources for transmitting the indication information, and determining, from the set of uplink control resources, the uplink control resource based on a number of bits of the indication information; or
determining one of the set of uplink control resources for hybrid automatic repeat request (HARQ) feedback as the uplink control resource based on the number of bits of the indication information, and the uplink control resource is an uplink control resource with a smallest index in the set of uplink control resources.

14. A network device for wireless communication, comprising:
at least one memory; and
at least one processor coupled with the at least one memory and configured to cause the network device to:
determine, from a plurality of transmission occasions (TOs) in a time duration for a configured grant (CG) configuration for a terminal device, a set of TOs for receiving indication information, wherein the indication information indicates usage status of at least one TO among the plurality of TOs; and
receive the indication information from the terminal device based on the determined set of TOs.

15. A method performed by a terminal device, the method comprising:
determining, from a plurality of transmission occasions (TOs) in a time duration for a configured grant (CG) configuration, a set of TOs for transmitting indication information, wherein the indication information indicates usage status of at least one TO among the plurality of TOs; and
transmitting the indication information to a network device based on the determined set of TOs.

16. The method of claim 15, wherein the set of TOs have a fixed interval, and the fixed interval is configured by the network device or predetermined.

17. The method of claim 15, further comprising:
receiving a bitmap from the network device, wherein the bitmap indicates the set of TOs for transmitting the indication information.

18. The method of claim 15, further comprising:
determining the set of TOs based on a number of the plurality of TOs.

19. The method of claim 15, further comprising:
determining a start TO of the set of TOs as one of:
a first TO of the plurality of TOs;
a first used TO of the plurality of TOs; or
a TO indicated by the network device.

20. A method performed by a network device, the method comprising:
determining, from a plurality of transmission occasions (TOs) in a time duration for a configured grant (CG) configuration for a terminal device, a set of TOs for receiving indication information, wherein the indication information indicates usage status of at least one TO among the plurality of TOs; and
receiving the indication information from the terminal device based on the determined sets of TOs.
